(19) United States
(12) Patent Application Publication
(10) Pub. No.: US 2023/0113517 A1
(43) Pub. Date: Apr. 13, 2023

(54) DENTAL MILLING MACHINE FOR THE PRODUCTION OF A DENTAL OBJECT

(71) Applicant: Ivoclar Vivadent AG, Schaan (LI)

(72) Inventors: Jonas REINHARDT, Igis (CH); Andreas GANTIOLER, Bludenz (AT); Hannes GURSCHLER, Bludenz (AT); Christian WELLINGER, Nüziders (AT)

(21) Appl. No.: 17/938,518

(22) Filed: Oct. 6, 2022

(30) Foreign Application Priority Data
Oct. 7, 2021 (EP) 21201449.2

(51) Int. Cl. B23Q 17/09; G05B 19/404

(52) U.S. Cl. CPC B23Q 17/0952; G05B 19/404; B23Q 11/0039

(57) ABSTRACT

A dental milling machine for producing a dental object having a sensor for detecting signals caused by a machining tool and an electronic controller for controlling the machining tool based on the detected signals.

### CROSS-REFERENCE TO RELATED APPLICATIONS

This application claims priority to European patent application No. 21201449.2 filed on Oct. 7, 2021, which disclosure is incorporated herein by reference in its entirety.

### TECHNICAL FIELD

The present invention relates to a dental milling machine for producing a dental object and dental milling method for producing a dental object.

### BACKGROUND

The longer a milling tool is in use, the duller it becomes as, for example, coated diamonds of the milling tool wear out. As a result, the milling tool is pushed to the side during machining and less material is removed. When producing dental objects, it can then happen that a manufactured crown does not fit on an intended die or has a poor fit because too little material has been removed.

Therefore, the milling tool of the dental milling machine is changed from time to time. The workpiece or milling tool is measured by the dental milling machine and then the milling paths are corrected accordingly. However, a complex and space-consuming measuring probe is required for this task. Often the milling tool is changed too early, resulting in a high material cost for the user. However, it can also happen that an insufficient quality of the milling tool is not detected or a used milling tool is clamped and not detected by the dental milling machine. This can even lead to the breakage of a milling cutter.

In addition, milling templates, which define the milling paths and the associated process parameters, such as feed rate or spindle speed, are designed for the worst possible case (worst case scenario) for each indication. However, this rarely occurs in practice (less than 20%). Therefore, this milling template is slow and inflexible. Conversely, this is not optimal for more than 80% of the milled parts. In addition, there is a high expenditure of time to develop the milling template.

US 20090129882, 20190209266, 20210379718, 20210294297, 20210132580, 4744242 and 6929476 are directed to machining and tool devices and are hereby incorporated by reference in their entirety.

### SUMMARY

It is the aim of the present invention to reliably detect the condition of a machining tool in a dental milling machine in a simple manner.

This technical problem is solved by subject-matter according to the independent claims. Technically advantageous embodiments are the subject of the dependent claims, the description and the drawings.

According to a first aspect, the technical problem is solved by a dental milling machine for producing a dental object, comprising a sensor unit for detecting signals caused by a machining tool; and an electronic control unit for controlling the machining tool based on the detected signals. By the dental milling machine, for example, the technical advantage of detecting the condition or wear of the machining tool caused by machining of the workpiece is achieved. When the condition of the machining tool is known, the milling program can be adjusted or corrected so that the fit of the manufactured dental object is always within specifications. The detected signals allow the dental milling machine to “feel” what is happening between the workpiece and the machining tool during machining. An appropriate correction can then be made.

In a technically advantageous embodiment of the dental milling machine, the signal is a sound signal generated in the workpiece by the machining tool, a vibration signal generated in the workpiece by the machining tool, and/or a force signal applied to the workpiece by the machining tool.

The sound signal can be a sound in the air or a sound in the workpiece. This achieves, for example, the technical advantage that the condition of the machining tool can be detected in a simple and quick manner with a high degree of precision.

In a further technically advantageous embodiment of the dental milling machine, the dental milling machine is configured to perform a simulation based on the detected signals in order to calculate a milling process. This provides, for example, the technical advantage that various milling processes can be simulated in advance with suitable parameters and on the basis of the detected state of the machining tool. From the set of simulated milling processes, it is then possible to select, for example, the one that enables the fastest machining of the dental object or the one that enables the gentlest milling process with the least wear of the milling tool.

In a further technically advantageous embodiment of the dental milling machine, the electronic control unit is configured to control a feed rate, a path distance and/or a rotational speed of the machining tool based on the detected signals. The electronic control unit may be configured to control the machining tool in real time based on the detected signals. This provides, for example, the technical advantage that the workpiece can be efficiently and accurately machined.

In a further technically advantageous embodiment of the dental milling machine, the control unit is configured to determine wear of the machining tool on the basis of the detected signals. This achieves, for example, the technical advantage that the machining tool can be replaced according to wear.

In a further technically advantageous embodiment of the dental milling machine, the control unit is designed to control the machining tool on the basis of the determined wear. A correction of the dimension can be controlled depending on the condition of the machining tool. This achieves, for example, the technical advantage that a machining accuracy can be additionally increased over the entire service life of a milling tool.

In a further technically advantageous embodiment of the dental milling machine, the sensor unit is configured to detect a spindle current signal. This achieves, for example, the technical advantage that the state of the machining tool can be determined in a simple manner.

In a further technically advantageous embodiment of the dental milling machine, the sensor unit is designed to detect the signals without contact with the workpiece. This can be done, for example, by a sensor unit that detects a sound signal, a vibration or a spindle current. The sensor unit is not in direct contact with the workpiece. This achieves, for example, the technical advantage that the state of the machining tool can be determined in a simple manner.

In a further technically advantageous embodiment of the dental milling machine, the sensor unit is mechanically coupled to the workpiece. The sensor unit is in direct contact with the workpiece. For this purpose, the sensor unit can be directly connected to the workpiece or the workpiece holder. This has the technical advantage, for example, that the signals generated during the machining of the workpiece can be accurately recorded.

According to a second aspect, the technical problem is solved by a dental milling method for producing a dental object, comprising the steps of detecting signals caused by a machining tool by a sensor unit; and controlling the machining tool based on the detected signals by an electronic control unit. The dental milling method achieves the same technical advantages as the dental milling machine according to the first aspect.

In a technically advantageous embodiment of the dental milling method, a simulation is performed based on the signals to calculate a milling process. The simulation may use a digital twin of the dental milling machine. This makes it possible to simulate a dynamic of the dental milling machine. This also achieves, for example, the technical advantage that the state of the machining tool can be detected easily and quickly with a high degree of precision.

In a further technically advantageous embodiment of the dental milling method, a path distance and/or a rotational speed of the machining tool is controlled on the basis of the detected signals. This also achieves, for example, the technical advantage that the workpiece can be machined quickly and precisely with as little wear as possible.

In a further technically advantageous embodiment of the dental milling method, a wear of the machining tool is determined on the basis of the signals. This also achieves, for example, the technical advantage that the machining tool can be replaced according to wear.

In a further technically advantageous embodiment of the dental milling method, the machining tool is controlled on the basis of the determined wear. This also achieves, for example, the technical advantage that a machining accuracy can be additionally increased.

In a further technically advantageous embodiment of the dental milling method, a spindle current signal is detected. This achieves, for example, the technical advantage that the state of the machining tool can be determined in a simple manner.

### BRIEF DESCRIPTION OF THE DRAWINGS

Examples of embodiments of the invention are shown in the drawings and will be described in more detail below.

FIG. 1 shows a schematic view of a dental milling machine;

FIG. 2 shows an error during the machining of a workpiece;

FIG. 3 shows a diagram of feed and load of a machining tool; and

FIG. 4 shows a block diagram of a dental milling method for producing a dental object.

### DETAILED DESCRIPTION

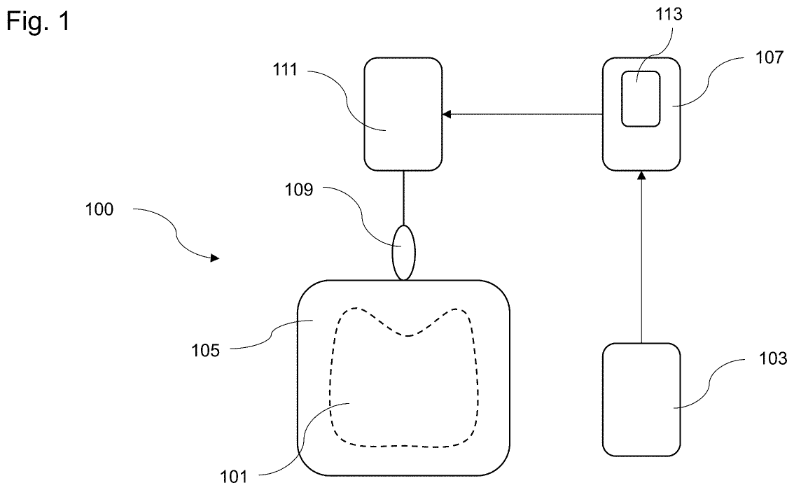

FIG. 1 shows a schematic view of a dental milling machine 100. The dental milling machine 100 is used to produce a dental object 101, such as a crown, a bridge, a veneer, an abutment, an inlay or an onlay. The dental object 101 is produced by the dental milling machine 100 by means of a machining process from a blank as a workpiece 105. For this purpose, a machining tool 109 is rotated by means of an electrically driven rotary spindle 111. The material of the workpiece is removed by the movable machining tool 109 until the desired spatial shape of the dental object 101 is achieved. The machining tool 109 may be a milling tool or a polishing tool for the workpiece 105.

The dental milling machine 100 includes a sensor unit 103 for detecting a signal caused or generated by the machining tool 109 when machining the workpiece 105. The signal corresponds to a physical quantity during machining of the workpiece 105, which may be, for example, a vibration, a structure-borne sound, an acoustic, or a force that occurs during machining of the workpiece 105. The sensor unit 103 is capable of detecting signals generated during the machining of the workpiece 105 by the machining tool 109. The signals may be detected individually or simultaneously. By the detection of the signals during machining of the workpiece, the dental milling machine 100 receives feedback during machining.

The detected signals are forwarded to an electronic control unit 107, where they are evaluated. After evaluation, the electronic control unit 107 controls the machining tool 109 on the basis of the detected signals. The evaluation of the signals and the adjustment of the control of the dental milling machine 100 is performed in real time. The electronic control unit 107 controls, for example, a rotational speed, a feed rate and/or a spatial movement of the machining tool 109.

In addition, the electronic control unit 107 can calculate wear of the machining tool 109 from the sensed signals and take this into account when controlling the machining tool 109. For example, if it is determined from the sensed signals that the diameter of the machining tool 109 has decreased, the machining tool 109 may be adjusted to compensate for the detected wear or bending of the tool. This process may then be repeated to continuously compensate for the wear of the machining tool 109.

The control unit 107 includes, for example, a microprocessor and an electronic data memory, such as a RAM memory. The data memory stores processing programs and digital data for the sensed signals. The microprocessor can further process the digital data.

Based on signals from the sensor unit 103, the state of the machining tool 109 can be determined and the milling process can be readjusted and corrected with respect to the milled dimensions. There may be a defined, for example linear, relationship between the state of the machining tool 109 and the sensed signals. For example, the greater the vibration signals, the greater the wear of the machining tool 109 may be. However, a neural network may also be trained to determine, for example, the state of the machining tool 109 based on the detected signals.

For example, the signal detected by the sensor unit 107 may be a sound signal generated by the machining tool 109 in the workpiece 105. The sound signal may be recorded by a microphone as the sensor unit 103. The electronic control unit 107 then evaluates the detected sound signal.

For example, the signal detected by the sensor unit 107 may be a vibration signal generated by the machining tool 109 in the workpiece 105. The vibration signal may be recorded by a vibration sensor as the sensor unit 103. The electronic control unit 107 then evaluates the detected vibration signal.

For example, the signal sensed by the sensor unit 103 may be a force signal applied to the workpiece 105 by the machining tool 109. The force signal may be recorded by a force sensor as the sensor unit 103. The electronic control unit 107 then evaluates the recorded force signal. This achieves, for example, the technical advantage that force peaks above the load limit of the machining spindle or the machining tool are avoided.

For example, the signal detected by the sensor unit 107 may be a spindle current signal from a spindle current flowing through an electric motor of a rotary spindle 111 during machining of the workpiece 105. The spindle current signal may be recorded by an ammeter sensor unit 103. The electronic control unit 107 evaluates the recorded spindle current signal.

The dental milling machine 100 thus measures the spindle current and slows down the process if the milling cutter is old or worn out. When optimal conditions prevail, the milling process can be accelerated.

The sensor unit 103 may detect the signals without contacting the workpiece 105. In this case, the sensor unit 103 does not directly contact the workpiece 105. For example, a microphone may record the sound signals as the workpiece 105 is processed and transmitted through the air over some distance.

However, the sensor unit 103 may also be directly mechanically coupled to the workpiece 105. For example, a microphone may record sound signals as the workpiece 105 is processed, transmitted directly through and measured at the workpiece 105.

The control unit 107 may use a learning curve from adaptive methods. For example, a trained artificial neural network 113 may be used to detect a state of the machining tool 109. The artificial neural network 113 is a system of hardware and/or software that mimics the functioning of neurons in the human brain.

To this end, the neural network 113 detects trained patterns in the signals, such as in the detected sound signals, vibration signals, force signals, or spindle current signals. If the neural network detects a trained pattern in the signals, that pattern may be associated with a particular condition or degree of wear of the machining tool 109. For example, if a particular vibration pattern occurs, the neural network will recognize that the machining tool has a wear rate of 10%. This correction can also be used in polishing, as the diameter of the polishing tool changes due to wear. However, this can also be solved by applying a constant force to the polishing tool.

By the dental milling machine 100, the machining process can always be run in an optimal range, for example as fast as possible with the least wear. Adjustment of the machining process can be ensured by the sensor unit 103. Since the dental milling machine 100 detects during the machining process whether it can be driven faster or whether more material can be removed, it is possible to speed up the machining process. Tool breakage and chipping (small chipping on the workpiece) can be effectively prevented by the dental milling machine 100.

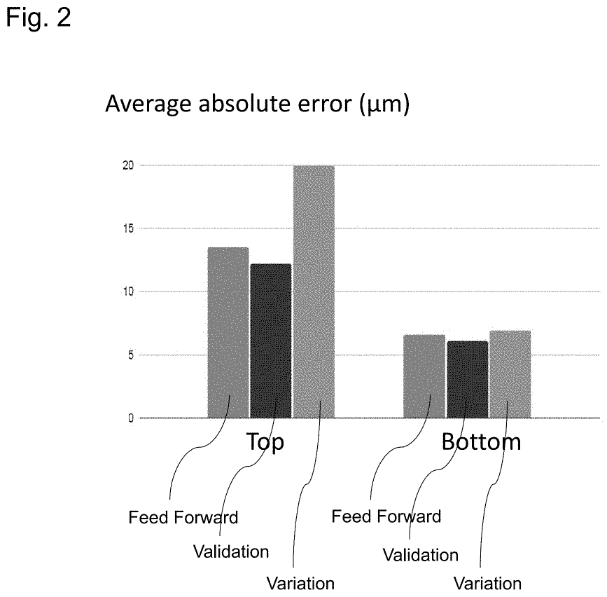

FIG. 2 shows an error in machining a workpiece 105 and a predictability of a milling tool condition at the top (top) and bottom (bottom) of the workpiece 105. The average absolute error of a prediction based only on vibration data is about 12 μm. Therefore, it is possible to predict the tool life to ±6 crowns using only measured vibration during the milling process. For this combination of dental milling machine 100 and machining tool 109, for example, an increase in deviation of 2 μm per milled crown is determined.

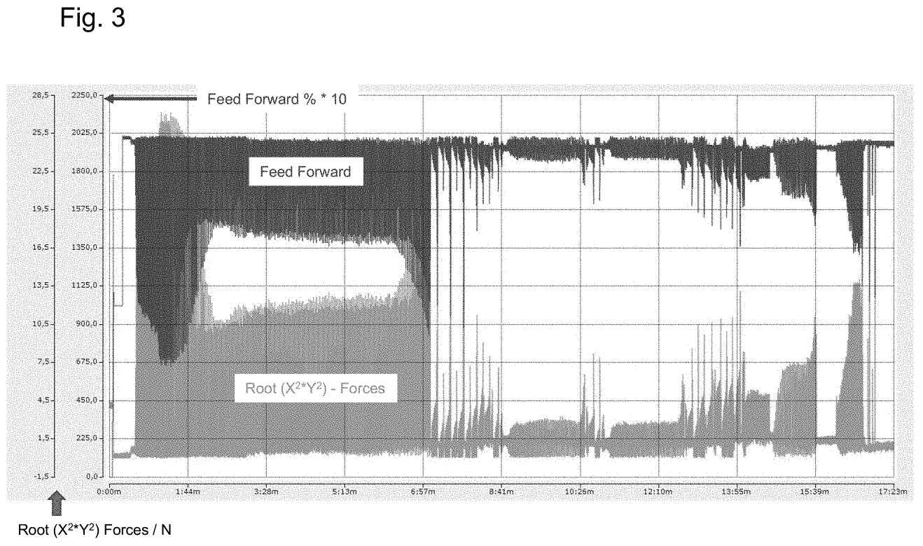

FIG. 3 shows a graph of feed and load on the machining tool 109 with real-time adaptive control. The load B on the machining tool 109 is calculated from the force on the machining tool in the X direction F_{X} and the force F_{y} on the machining tool in the y-direction as

B=\sqrt{Fₓ²+F_{y}²}

When the load B increases, the control unit 107 decreases the feed rate accordingly in real time.

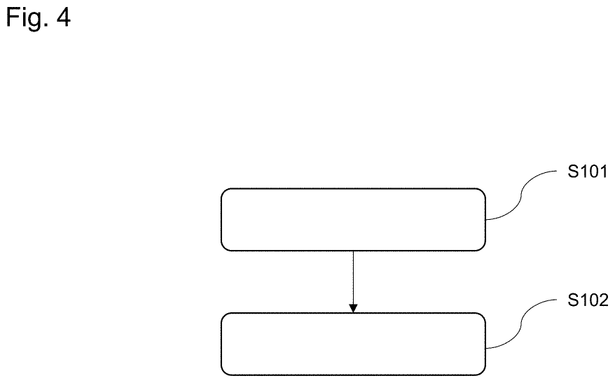

FIG. 4 shows a block diagram of a dental milling method for producing a dental object. The dental milling method comprises the step S101 of detecting signals caused by the machining tool 109 by a sensor unit 103; and the step S102 of controlling the machining tool 109 based on the detected signals by an electronic control unit 107.

The dental milling process achieves the technical advantages that dental objects can be manufactured more precisely and there is less waste. In addition, the dental milling process is more robust than conventional processes.

The dental milling machine 100 may be configured to perform a simulation based on the acquired signals to calculate a milling process. In this case, multiple simulations with different parameters may be performed. From these simulations, the parameters that enable the desired machining process are then selected.

In a gentle milling process, for example, less wear is generated on the milling tool so that more workpieces can be machined overall. In a fast milling process, the dental object is milled out of the workpiece in the fastest way possible. In a precision milling operation, the dental object is produced with the highest possible surface quality and fit. The parameters for these operations are obtained from the simulations.

All of the features explained and shown in connection with individual embodiments of the invention may be provided in various combinations in the subject matter of the invention to simultaneously realize their beneficial effects.

All method steps can be implemented by means suitable for executing the respective method step. All functions that are executed by the objective features can be a method step of a method.

The scope of protection of the present invention is given by the claims and is not limited by the features explained in the description or shown in the figures.

### REFERENCE LIST

100 Dental milling machine
101 Dental objects
103 Sensor unit or sensor
105 Workpiece
107 Control unit or controller
109 Machining tool
111 Rotary spindle
113 Neural network

1. A dental milling machine (100) for producing a dental object (101), comprising:
a sensor (103) for detecting a signals caused by a machining tool (109); and
an electronic controller (107) for controlling the machining tool (109) on the basis of the detected signals.

2. The dental milling machine (100) according to claim 1,
wherein the detected signals comprise at least one of a sound signal generated by the machining tool (109) in the workpiece (105), a vibration signal generated by the machining tool (109) in the workpiece (105), and/or a force signal applied by the machining tool (109) to the workpiece (105).

3. The dental milling machine (100) according claim 1,
wherein the dental milling machine (100) is adapted to perform a simulation based on the detected signals to calculate a milling process.

4. The dental milling machine (100) according to claim 1,
wherein the electronic controller (107) is adapted to control a feed rate, a path distance and/or a rotational speed of the machining tool (109) based on the detected signals.

5. The dental milling machine (100) according to claim 1,
wherein the controller (107) is adapted to determine a wear of the machining tool (109) based on the detected signals.

6. The dental milling machine (100) according to claim 1,
wherein the controller (107) is adapted to control the machining tool (109) based on the detected wear.

7. The dental milling machine (100) according to claim 1,
wherein the sensor (103) is adapted to detect a spindle current signal.

8. The dental milling machine (100) according to claim 1,
wherein the sensor (103) is adapted to detect the signals without contact with the workpiece (105).

9. The dental milling machine (100) according to claim 1,
wherein the sensor (103) is mechanically coupled to the workpiece (105).

10. A dental milling method for producing a dental object, comprising the steps of:
detecting (S101) signals caused by a machining tool (109) by a sensor (103); and
controlling (S102) the machining tool (109) on the basis of the detected signals by an electronic controller (107).

11. The dental milling method according to claim 10,
wherein a simulation is performed based on the detected signals to calculate a milling process.

12. The dental milling method according to claim 10,
wherein a feed rate, a path distance and/or a rotational speed of the machining tool (109) is controlled based on the detected signals.

13. The dental milling method according to claim 10,
wherein wear of the machining tool (109) is determined based on the detected signals.

14. The dental milling method according to claim 13,
wherein the machining tool (109) is controlled based on the detected wear.

15. The dental milling method according to claim 10,
wherein a spindle current signal is detected.
